(19) United States
(12) Patent Application Publication
(10) Pub. No.: US 2012/0291823 A1
(43) Pub. Date: Nov. 22, 2012

(54) Portable hanging device for washing, drying and storing a wetsuit

(76) Inventors: John Trent, Ventura, CA (US); Daniel Callaghan, Ventura, CA (US); John Stump, Santa Barbara, CA (US)

(21) Appl. No.: 13/068,787

(22) Filed: May 19, 2011

(51) Int. Cl. B08B 3/00

(52) U.S. Cl. 134/115 R

(57) ABSTRACT

A device for rinsing, drying and storing wetsuits. A hanger hook is coupled to a waterline connection and to internal and external irrigation elements disposed to rinse the inside and outside of a wetsuit hanging on the hanger. A shroud is provided which is disposed to hang from the hanger space away from the suit to confine spray. An optional closable drain for the shroud allows for the movement of the suit to a suitable location for draining and drying.

### RELATED APPLICATIONS

Not Applicable

### FEDERALLY SPONSORED RESEARCH

Not Applicable

### SEQUENCE LISTING

Not Applicable

### BACKGROUND OF THE INVENTION

This invention relates to the washing, drying, and storage of wetsuits and specifically to a device which conveniently washes the interior and exterior of a wetsuit with minimum labor, confines the water used for the washing, and provides for both storage and drying of the wetsuit in a convenient and visually attractive manor.

Wetsuits are used in a variety of aquatic activities, such as surfing, scuba diving, kite-boarding and the like. Particularly when these activities take place in salt water, it is vital that the wetsuit be rinsed off, and dried in a manner that minimizes long term exposure to sunlight. The rubber and rubber-like materials used in the construction of wetsuits are highly susceptible to breakdown and damage due to both saltwater and sunlight, and the combination of the two is very damaging to wetsuit materials. Thus a wetsuit that is not rinsed off, then dried, in a relatively dark area will suffer significant damage and decrease in useful life. Moreover the material degradation due to salt and sunlight tends to be a loss of structural integrity over a wide area, and thus generally is not easily reparable. And even if a suit is not left in sunlight, unless it is hung properly to dry, it can also be damaged by mildew and rot.

As modern quality wetsuits generally can cost upwards of $300 for a surf suit or more than $1000 for a dive suit, and the type of damages sustained by improper or no rinsing/drying can decrease a suit's lifetime from several seasons to less than one, the need to properly care for a suit is clear. However as anyone who has ever had to care for a wetsuit will attest, washing them is messy and difficult, water needs to be directed to both the inside and outside of a cumbersome object, so spray is difficult to manage, and the drying of a heavy dripping suit is very problematic without damage due to the hanger. Moreover a dripping suit is inconvenient to handle and particularly inconvenient to bring into the right drying environment, such as a garage or inside a dwelling.

As a consequence of the difficulties of dealing with a used, often sandy suit, and coupled with the fact that cleaning and drying often needs to take place right after a physically demanding activity, very few users are conscientious about proper suit care. In fact because it is difficult to do properly without making a mess, many users just leave the suit, unwashed, crumpled up out in the sun after a session and live with the fact that they will need to get a new one every few months.

Although a variety of products and ideas have been proposed to make the task of rinsing and storing a wetsuit easier, to date no one solution really addresses all of the issues and thus no effective solution is currently available to users. To be truly usable, the solution needs to allow for easy handling of the suit while rinsing both the inside and outside without a need for clumsy manipulation of the suit and water source; it needs to confine the spray during rinsing; it needs to allow easy and neat moving of the suit to a proper drying environment and/or provide the proper environment; and it needs to store the suit in a non-damaging fashion while drying and before the next use.

Thus it is the object of this invention to provide a wetsuit rinsing, drying and storage device that addresses all of the above mentioned needs in a cost effective and usable manner. A further advantage of such a device is the positive environmental impact of reduced toxic neoprene production due to the extended wetsuit lifespan. This reduces the need to purchase a new suit every year or so.

### BRIEF SUMMARY OF THE INVENTION

The invention is device for washing, drying and storing a wetsuit. A hanger for the wetsuit including irrigation elements for wetting the outside and the inside of the wetsuit, a waterline connection, such as a hose coupling, between the irrigation elements and an external water source, a shroud spreader which may be one of the irrigation elements coupled to the hanger and a water catching shroud. The shroud is supported by the spreader to enclose a wetsuit on the hanger with space between the wetsuit and shroud and includes a drain disposed to drain water from the shroud and wetsuit.

In various embodiments, the drain may be a non-closable open space in the bottom of the shroud, a non-closable orifice, or a closable orifice in the bottom of the shroud, such as a pipe/cap, clampable tube, or plug. The shroud may also include mesh vents or removable flaps to facilitate drying.

In one embodiment, the external irrigation element may include a first section that irrigates from the top of the wetsuit down and a second section that extends down the length of the wetsuit and irrigates along the length of the wetsuit. In a particular version, the second section is a spiral pipe with irrigation holes looping around the wetsuit from top to bottom. In various embodiments, the internal irrigation element is a part of hanger arms supporting the wetsuit shoulders and neck regions. Optionally, an irrigation element may be provided to rinse and store booties, and gloves.

In a specific embodiment, the external irrigation element couples to a hanger hook and the hose coupling and may include pipes extending from the hose coupling over the top of the wetsuit connecting to an closed loop pipe surrounding the shoulders of the wetsuit, and the pipes contain a plurality of water outlets directed over the top portion of the wetsuit. The closed loop pipe section may be disposed as the shroud spreader. The hanger arms are coupled to the hose coupling, and may contain internal piping or be hollow and also have a plurality of water outlets directed into the interior of the wetsuit. In a particular embodiment the closed loop pipe is oval shaped. Optionally third irrigation elements may be added to rinse and store booties, gloves, hoods, or other accessories such as flippers, masks, fins, sandals and the like.

### BRIEF DESCRIPTION OF THE DRAWINGS

The invention will be better understood by referring to the following figures.

FIG. 1 depicts two views of the main features of the invention.

FIGS. 2a, b and c show various embodiment of the shroud.

FIG. 3 depicts details of the hanger, hose coupling and external irrigation element.

FIG. 4 depicts another external irrigation embodiment.

FIG. 5 depicts details of the hanger and internal irrigation element.

FIG. 6 depicts an embodiment with the provision for additionally rinsing and drying booties, and gloves.

FIG. 7 depicts details of a specific version of the hanger, irrigation elements, and hose coupling.

### DETAILED DESCRIPTION OF THE INVENTION

In the following description and accompanying drawings, exemplary implementations are shown of the novel set of features that comprise the various embodiments of the invention. Variations on these exemplary depictions will occur to a skilled practitioner. For instance the shapes and relative size and placement of the elements could vary from the depictions shown to a degree and still function acceptably. Thus the invention should not be assumed limited by the exact exemplary depictions.

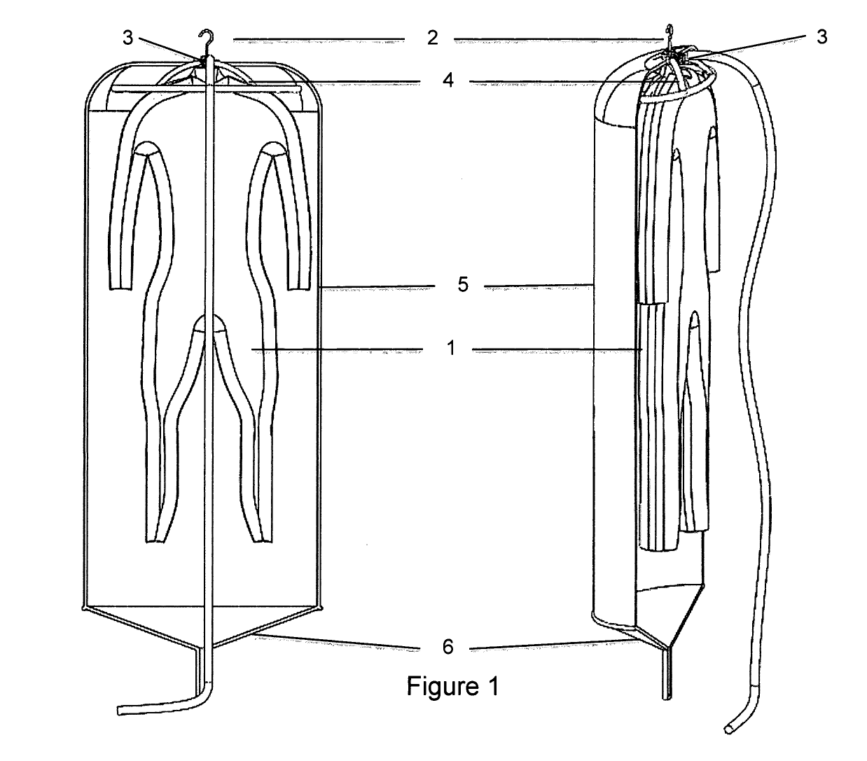

In FIG. 1 the various elements that comprise the invention are shown. A wetsuit 1 is placed on a hanger 2. Hanger 2 is coupled with a waterline connection such as a hose coupling 3 which is connected to irrigation elements 4 which are placed both external and internal to wetsuit 1. A shroud 5 is hung from a spreader, which in the figure is depicted as part of irrigation element 4, but could be a separate element. The spreader and the shroud 5 are configured to hang about the wetsuit but not actually touching it, leaving enough space for drying. A drain 6 at the bottom of the shroud allows for water from the irrigation elements to exit the shroud.

Thus in operation, a user opens the shroud 5 which may be accomplished by a variety of means known in the art, such as zippers, Velcro closure, or the like, or even just lifting it up, and hangs a wetsuit 1 on hanger 2 which is hung from any suitable location. Shroud 5 is closed, and a hose is connected to coupling 3 and water is turned on. Water is directed to wetsuit 1 internally and externally by irrigation elements 4 thus rinsing both the inside and outside of the suit. The water is contained by shroud 5 and drained by drain 6. When done, the suit is protected from sunlight by shroud 5 and is configured to properly dry.

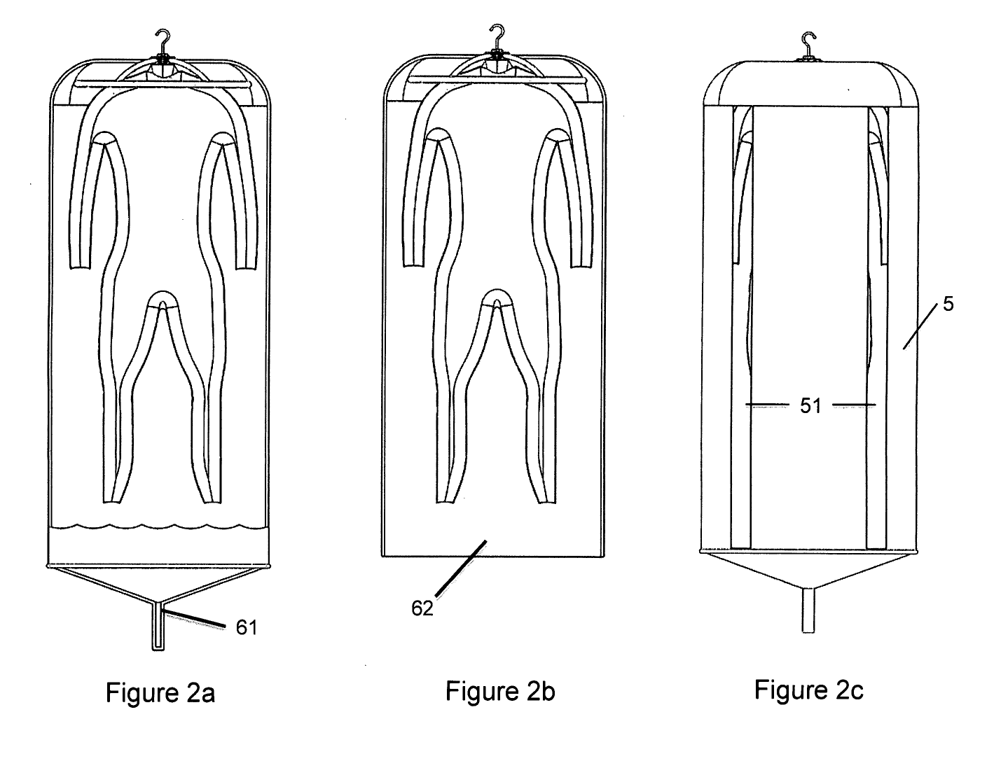

Variations on the basic invention are shown in FIGS. 2a, b and c. FIG. 2b is the most basic implementation where drain 6 is an always-open portion of the shroud near or at its bottom. FIG. 2a is a preferred implementation where drain 6 is a closable (or non-closable) orifice, such as threaded pipe and cap or hose/hose clamp. This implementation allows a user to rinse the suit at one location and move it somewhere else to drain the water, such as inside to hang in a shower. FIG. 2c shows an alternate embodiment where shroud 5 includes removable side flaps or mesh vents 51 which may facilitate drying after rinsing. Again a skilled user will contemplate a variety of ways to implement open and closable drains or side flaps (zippered, velcroed etc.) so the implementations shown and described are to illustrate the basic idea and should not be considered as limiting.

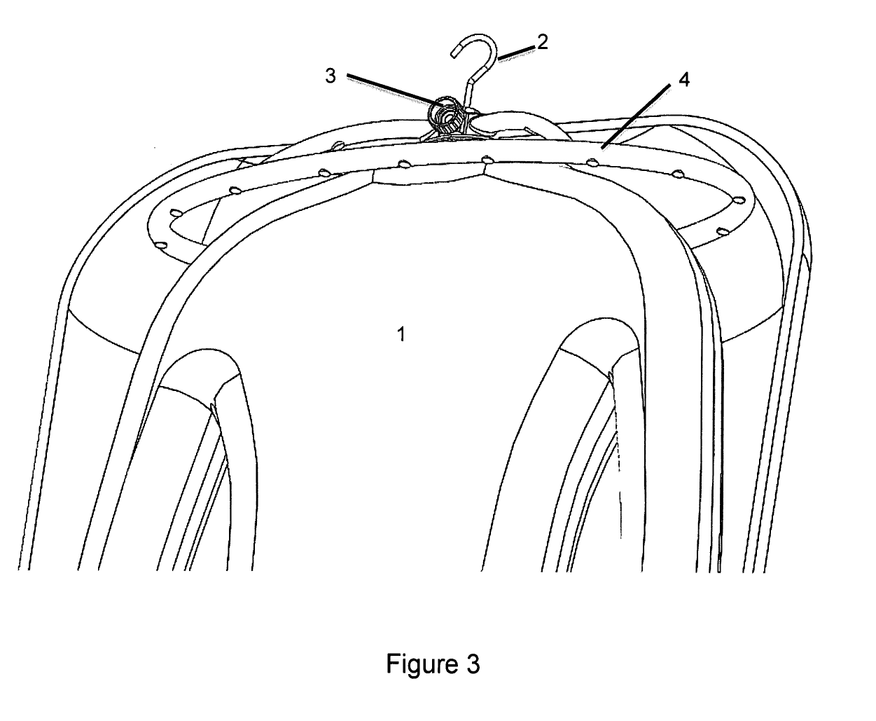

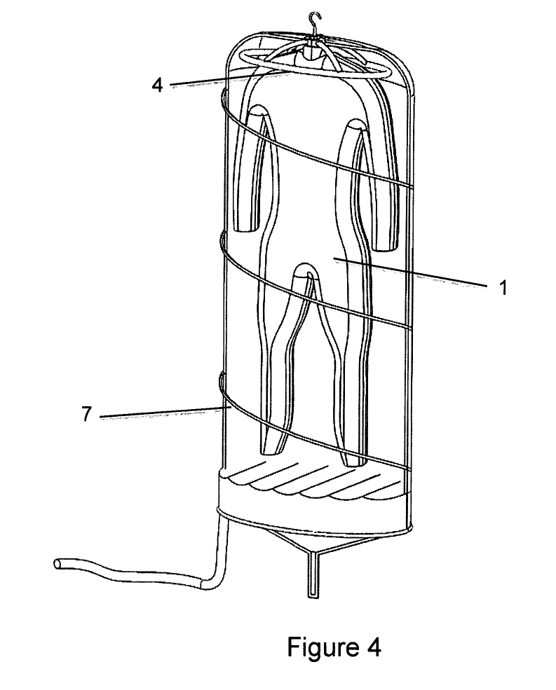

FIG. 3 shows a possible implementation of external irrigator 4. Hose coupling 3 is connected to pipes with water outlets spanning the top of suit 1 and to a loop sprayer pipe disposed to spray the main body of the suit 1. Element 4 in this implementation serves as the shroud spreader. FIG. 4 shows an embodiment where irrigator 4 is connected to additional element 7 which is a spiral pipe wrapping around the body of the suit. Element 7 may also be connected to the hose coupling and have water outlets directed to the suit. Element 7 also serves as a frame for the shroud, fixing it with respect to the suit.

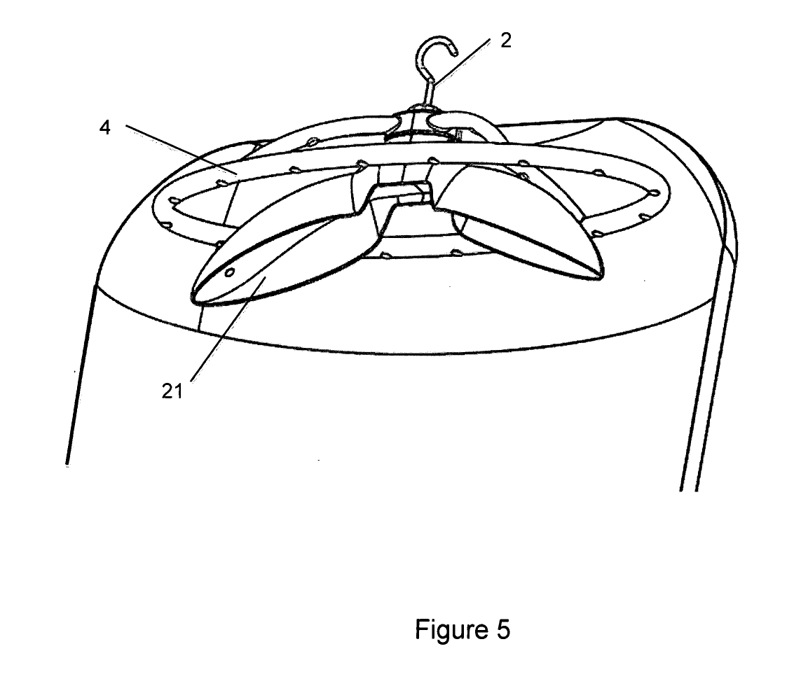

FIG. 5 shows a specific implementation of internal irrigator 4. Hanger 2 is connected to hanger arms 21, which may be hollow or contain piping connected to the coupling. Element 21 also contains water outlets directing water into the interior of the suit.

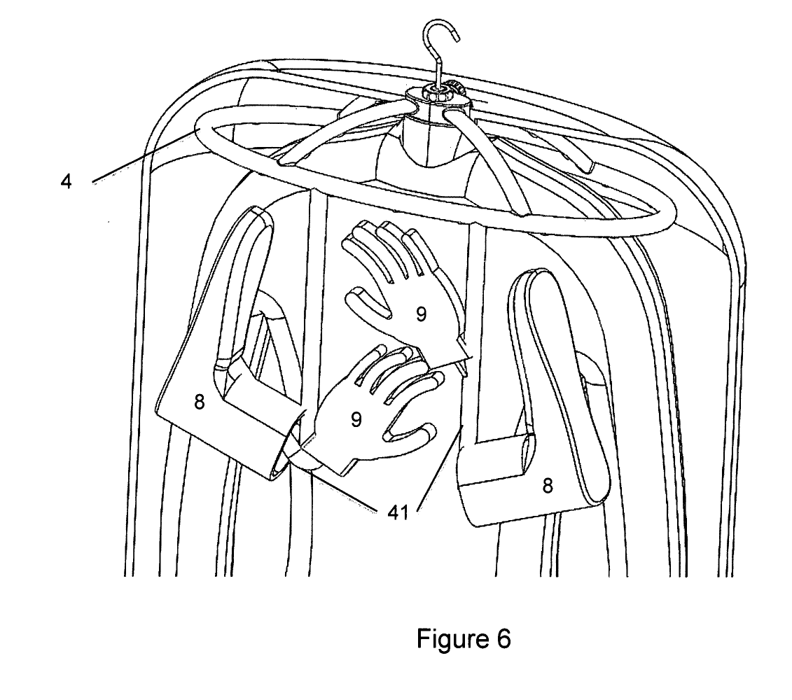

Wetsuits are often used in conjunction with booties and gloves which are also inconvenient to rinse and dry. As shown in FIG. 6, additional irrigation elements 41 containing a plurality of water outlets are connected to the waterline connection and attached to the shroud spreader/irrigation loop 4. These additional elements serve as a rinsing system and a drying/hanging system for the booties 8 and gloves 9. In one embodiment of the application, these additional irrigators can be removable. The additional elements may be used to rinse and dry a variety of water sport accessories such as hoods, fins, goggles, sandals, snorkels and the like.

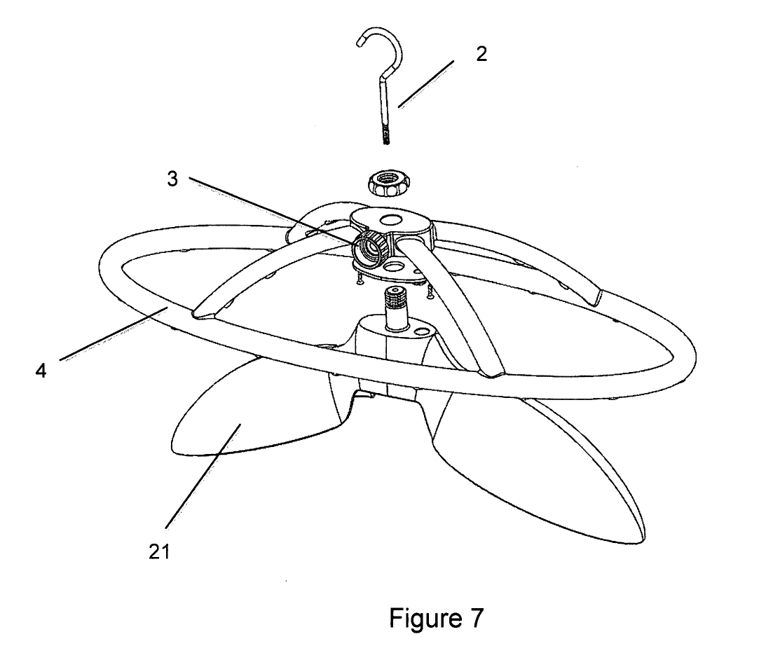

FIG. 7 shows an exemplary implementation of the hanger 2, waterline connection 3, irrigator 4 and hanger arm 21 showing how it all could fit together in a particular embodiment. In an as-built exemplary implementation, the following detailed elements were employed to achieve the functionality as described:
The Hanger 2
   Includes a steel hook that is attached to top, of a plastic body. This hook is chosen with sufficient strength to hold up to 100 pounds. The connection is made from male groves in the steel hanger, and female groves in the plastic.
Hanger Arms 21 (Internal Irrigator)

The main body is about 5″ wide and about 20″ in length. The length and the width allow for separation of the suit. Separating the suit allows air flow and support in the arms and shoulders of the suit. This will distribute the weight, so the suit will not stretch or tear, and allow for faster drying time. The body is hollow, and connected to the hose coupling, with small spray holes in the bottom. This allows the water to flow through the inside of the hanger and out the spray holes at the bottom. This will allow the inside of the suit to be rinsed.
The Sprayer Loop 4 (External Irrigator)
   The Sprayer Loop is secured to the hanger through a plastic nut. This nut fastens to the hanger. The hanger has a sealing port allowing for high pressure water to flow through. The sprayer loop is about 24 inches long and 10 inches wide. The sprayer loop is removable to allow for easier storing. At the end of the sprayers there are small holes directed down. This allows the water to spray through the holes toward the outside of the suit. This allows the outside of the suit to be rinsed.
Hose Coupling 3 (Waterline Connection)
   The hose attachment is standard Garden Hose inch diameter. A quick connect system can be added for easy set up.
The Garment Bag 5 (Shroud)
   The Garment bag is constructed of strong heat sealed PVC, and is completely waterproof. It is coated with a heavy U.V. treatment that helps reflect the sun. This garment bag will allow the suit to be hung, rinsed and stored outside if needed. The bag is designed with a reservoir at the bottom to allow the water to flow out of the suit. A cap can be placed on the reservoir to stop the water. This is only recommended after the suit has been rinsed. The cap can be placed the on reservoir, so the device can be moved into an area indoors where the suit can be allowed to dry.

The foregoing description of the embodiments of the present invention has shown, described and pointed out the fundamental novel features of the invention. It will be understood that various omissions, substitutions, and changes in the form of the detail of the systems and methods as illustrated as well as the uses thereof, may be made by those skilled in the art, without departing from the spirit of the invention. Consequently, the scope of the invention should not be limited to the foregoing discussions, but should be defined by appended claims.

We claim:

1. A device for washing, drying and storing a wetsuits, comprising;
a hanger for the wetsuit comprising a first irrigation element for wetting the outside of the wetsuit, and a second irrigation element for wetting the inside of the wetsuit,
a waterline connection between the irrigation elements and an external water source,
a shroud spreader coupled to the hanger and a water caching shroud, wherein the shroud is supported by the spreader to enclose a wetsuit on the hanger with space between the wetsuit and shroud; and,
a drain disposed to drain water from the shroud and wetsuit.

2. The device of claim 1 wherein the drain is at least one of a non-closable open space in the bottom of the shroud, a non-closable orifice, or a closable orifice in the bottom of the shroud.

3. The device of claim 1 wherein the shroud includes side vents to facilitate drying.

4. The device of claim 1 wherein the first irrigation element comprises at least one of a first section that irrigates from the top portion of the wetsuit down and a second section that extends down the length of the wetsuit and irrigates along the length of the wetsuit.

5. The device of claim 4 wherein the second section is a spiral pipe with irrigation holes looping around the wetsuit from top to bottom.

6. The device of claim 1 wherein the first irrigation element is also the shroud spreader.

7. The device of claim 6 wherein the second irrigation element is a part of the hanger arms supporting the wetsuit's shoulders and neck regions, while irrigating the inside of the wetsuit.

8. The device of claim 7 wherein;
the first irrigation element couples to a hanger hook and the waterline connection and comprises pipes extending from the waterline connection over the top of the wetsuit connecting to a closed loop pipe surrounding the shoulders of the wetsuit, wherein the pipes contain a plurality of water outlets directed over the upper portion of the wetsuit, and the closed loop pipe section disposed as the shroud spreader, and;
Hanger arms with internal piping and a plurality of water outlets directed into the interior of the wetsuit, coupled to the waterline connection.

9. The device of claim 1, additionally comprising, at least two third irrigation/hanger elements coupled to the hose coupling configured to rinse and store at least one of bootie and gloves.
